(19) United States
(12) Patent Application Publication
(10) Pub. No.: US 2026/0150778 A1
(43) Pub. Date: Jun. 4, 2026

(54) PLANTER SEED CONVEYOR SYSTEM

(71) Applicant: Harvest International, Inc., Storm Lake, IA (US)

(72) Inventors: Jeffrey Alan Sivinski, Cherokee, IA (US); Byron James Friesen, Storm Lake, IA (US)

(21) Appl. No.: 19/407,786

(22) Filed: Dec. 3, 2025

Related U.S. Application Data
(60) Provisional application No. 63/727,311, filed on Dec. 3, 2024.

(51) Int. Cl. A01C 7/10; A01C 7/08; A01C 7/16

(52) U.S. Cl. CPC A01C 7/105; A01C 7/085; A01C 7/16

(57) ABSTRACT

An agricultural bulk seed planter includes a toolbar assembly with a frame, a bulk seed hopper mounted on the frame, a series of row planters mounted on the frame, with each row planter having a seed meter, and a series of mechanical conveyors extending between the frame and the seed meters. Each conveyor has an inlet to receive seed from the hopper and an outlet to discharge seed to one of the seed meters. The seed meter includes a seed level or volume sensor, which sends signals to a remote controller, which in turn adjusts the operation of the conveyors to maintain a proper seed level or volume in the seed meters.

### CROSS REFERENCE TO RELATED APPLICATIONS

This application claims priority under 35 U.S.C. § 119 (e) to provisional patent application U.S. Ser. No. 63/727,311, filed Dec. 3, 2024. The provisional patent application is hereby incorporated by reference in its entirety herein, including without limitation: the specification, claims, and abstract, as well as any figures, tables, appendices, or drawings thereof.

### BACKGROUND

Agricultural crops are typically grown from seeds planted in the soil using various types of agricultural equipment. Some seeds are very delicate, and can easily crack or split during the planting operation. These cracked or split seeds normally will not germinate. Thus, handling the seeds is important to reduce the risk of seed damage, and improve the rate of germination, for improved yield and profitability. One example of a delicate seed is a peanut seed, which is a dicotyledon seed.

Conventional seed planting equipment includes a tractor to pull a toolbar through the field, with a bulk seed hopper and row planters mounted to the toolbar. The seeds, including delicate seeds, are dropped from the bulk seed hopper through long hoses, tubes, or troughs, and then delivered to a seed meter on each row planter. This movement of the seeds can cause seed damage, including splitting into two or more parts. Also, the coating on the seeds can be damaged, which reduces seed germination, and thus yield and profits for the farmer.

Some conventional bulk seed delivery systems use pneumatic conveyors to move the seeds to the seed meter. However, the air pressure and intermingling of blowing seeds may damage the seed, thereby resulting in poor germination.

Each type of seed (i.e. peanut, corn, soybeans, etc.) can vary in size from small to large. The size variation can cause seed bridging at various points between the bulk seed hopper and the seed meter, which slows or stops the seed flow to a point or condition wherein the meter is not discharging seeds for planting in the soil. Bridging requires the planting operation to cease, and the various components to be opened to find, expose, and break up the blockage, to allow the seed to properly flow to the seed meter. Planting systems that use flexible or corrugated hoses or tubes to deliver seed to the meter are especially vulnerable to seed bridging. Bridging reduces planting efficiency and potential loss of profit due to delayed planting.

Different crops utilize different planting populations. For example, peanut seeds are planted with a high population, with a target of six seeds per foot (i.e. every two inches) in the seed furrow. High planting population operations deplete seed from the bulk seed hoppers very quickly, particularly for large sized seeds. These large-size and high population seeds slow the planting process due to more frequent refilling of the hopper.

Current or conventional seed planters, such as for peanut seeds, use seed boxes mounted on the row planters, with seed meters mounted to the seed box, such that the seeds are directly funneled from the seed box to the seed meter. These systems typically utilize a three-bushel seed box, which empties out quickly, particularly for large seeds and high planting populations. The seed boxes add weight to the planter row unit, thereby increasing forces and stress to the row unit frame components. The increased weight from the seed boxes on the row unit also increases soil compaction around the planted seed, which may reduce yield, and can cause erratic seed planting depth.

Other planting systems mount the seed hoppers on the toolbar frame, and supply seed from the hoppers to the row units via long, flexible, convoluted and/or corrugated tubes. As the planter row unit flexes up and down following the soil surface contour, the flexible hose also flexes up and down, or extends and retracts, to eliminate the risk of the seed delivery hose or tube from disconnecting from the seed meter. The corrugated or pleated sidewall of the seed hose allows the hose to stretch and compress, but these pleats also catch and hold seed, and can cause fragile seeds to crack or split, or cause damage to the seed coating. This damage reduces seed germination and profit to the farmer.

Peanut and similar planting systems have limited seed capacity. For example, a conventional peanut planting system has the seed box associated with each row planter, with each seed box carrying approximately 12 bushels of seed, depending on the seed size. This relatively small size of the seed boxes on the row units limits the acreage which can be planted between seed box refills.

Frame mounted bulk seed hoppers are often larger than the row mounted seed boxes. These larger hoppers are mounted higher on the planter frame to allow the seed to be delivered by gravity from the bulk seed hopper through the convoluted flexible seed tubes. However, this configuration creates transport height issues on larger assemblies, and therefore are typically mounted on smaller 6-8 row planters. These small planters restrict the number of acres which can be planted per day.

Accordingly, a primary objective of the present invention is the provision of an improved seed planter assembly mounted on a toolbar frame and having a mechanical conveyor to gently transport seed from the bulk seed hopper to the seed meter on the row planter unit.

Another objective of the present invention is the provision of a method of conveying seed from a seed hopper to a seed meter using a mechanical conveyor.

A further objective of the present invention is the provision of a mechanical conveyor assembly that transports seeds from a hopper on an agricultural planter frame to a seed meter on a row unit.

Yet another objective of the present invention is the provision of an agricultural seed planter having a seed hopper, a plurality of seed meters, and a plurality of mechanical conveyors to convey seed from the hopper to the respective seed meters.

Another objective of the present invention is the provision of a series of mechanical conveyors for an agricultural planter which can be remotely and individually controlled during seed planting operations.

Still another objective of the present invention is the provision of an agricultural seed planter having seed meters with seed level sensors to send signals to a remote controller for adjusting functionality of seed conveyors to carry seed from a hopper to the seed meters.

Yet another objective of the present invention is the provisions of a seed conveyor extending between a seed hopper and a seed meter, and which floats in the field during planting operations.

These and other objectives become apparent from the following description of the invention.

### SUMMARY

An agricultural seed planter is provided with a hopper mounted on a toolbar frame, and a plurality of row units on the frame, with each row unit having a seed meter. A series of mechanical conveyors are mounted between the seed hopper and the seed meters, and which transport seed from the hopper to the associated seed meters. Each conveyor comprises a substantially horizontal belt, with flexible tubes or hoses at the conveyor inlet and the conveyor outlet. Each conveyor is pivotally mounted to the hopper, so to be adapted to rise and fall as the planter traverses uneven fields during the planting operation. Each seed meter includes a seed level sensor, which sends signals corresponding to the level of seed in the seed meter to a remote controller, such that the remote controller adjusts the operation of each conveyor individually, so as to maintain a proper level or volume of seed in the respective seed meters.

### BRIEF DESCRIPTION OF THE DRAWINGS

FIG. 1 is a perspective view of a planter assembly with a seed conveyor according to the present invention.

FIG. 2 is an enlargement of the right end of the assembly shown in FIG. 1

FIG. 3 is a further enlargement of the right end of the assembly shown in FIG. 2.

FIG. 4 is a perspective view showing the seed conveyor and seed meter assembly from FIGS. 1-3.

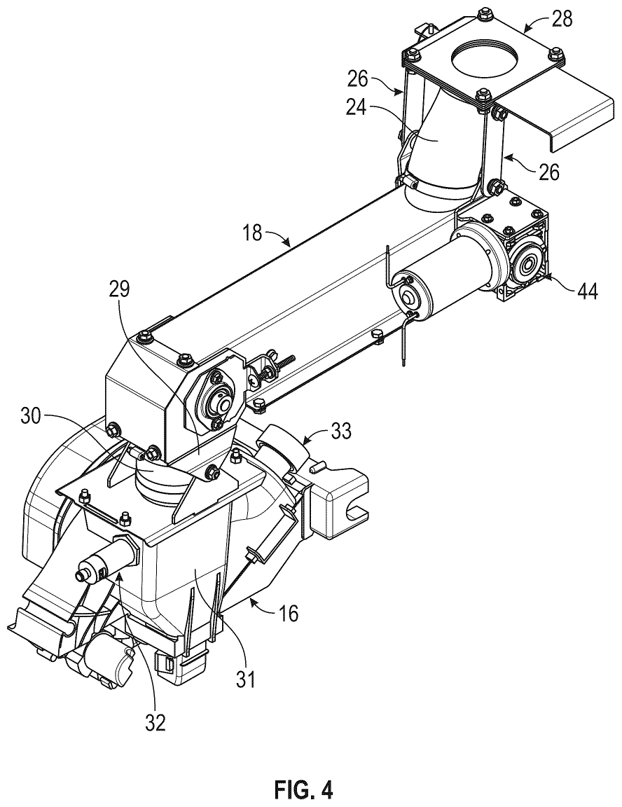

FIG. 5 is another perspective view of the seed conveyor and seed meter assemblies.

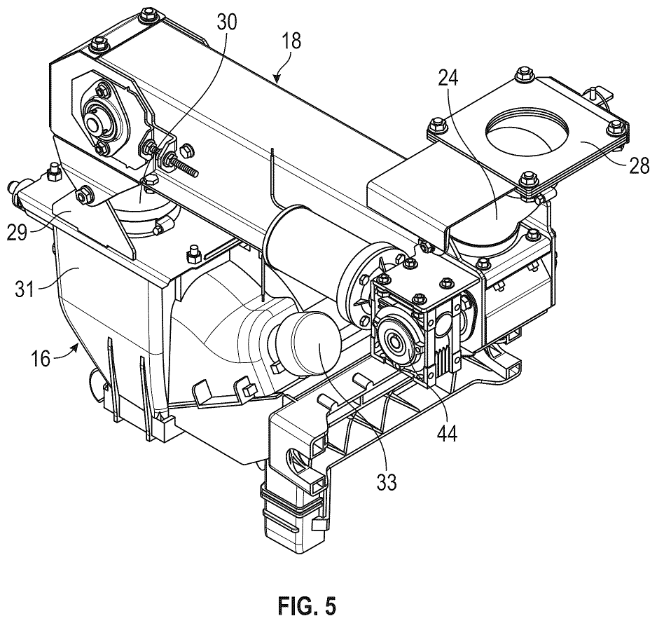

FIG. 6 is a further perspective view of the seed conveyor and seed meter assemblies of the present invention.

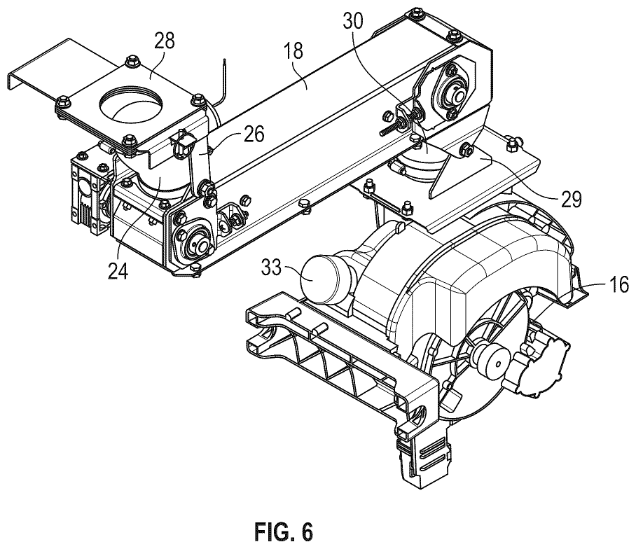

FIG. 7 is a side elevation view of the seed conveyor and seed meter shown in FIGS. 4-6

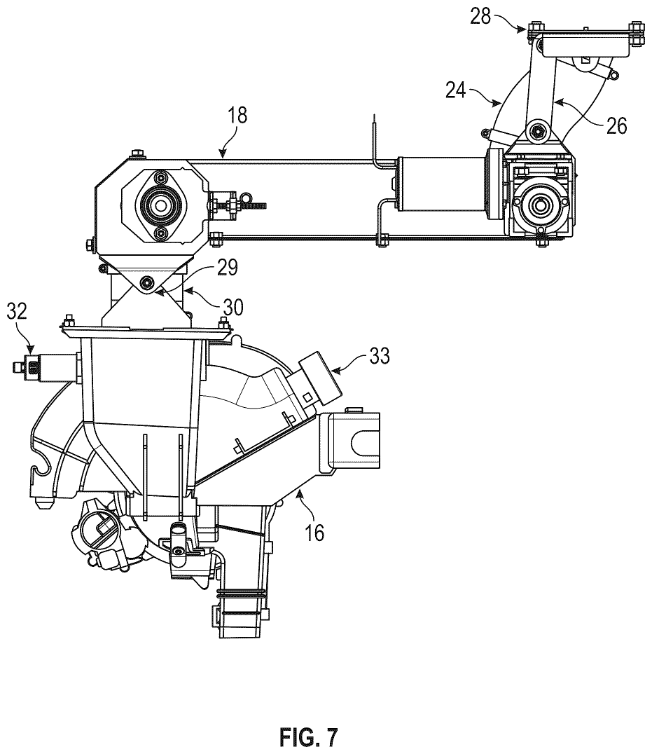

FIG. 8 is a top plan view of the seed conveyor and seed meter shown in FIGS. 4-6

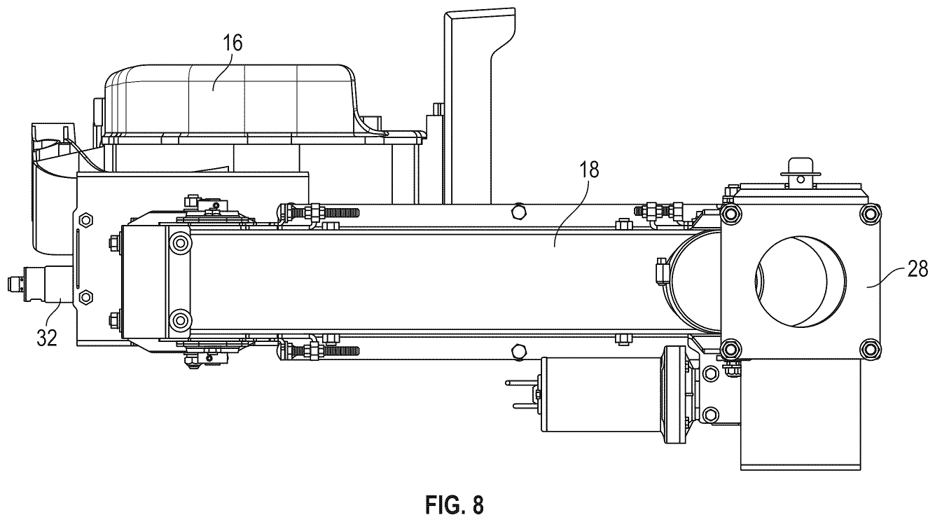

FIG. 9 is a perspective view of the seed conveyor for the seed planter assembly, according to the present invention.

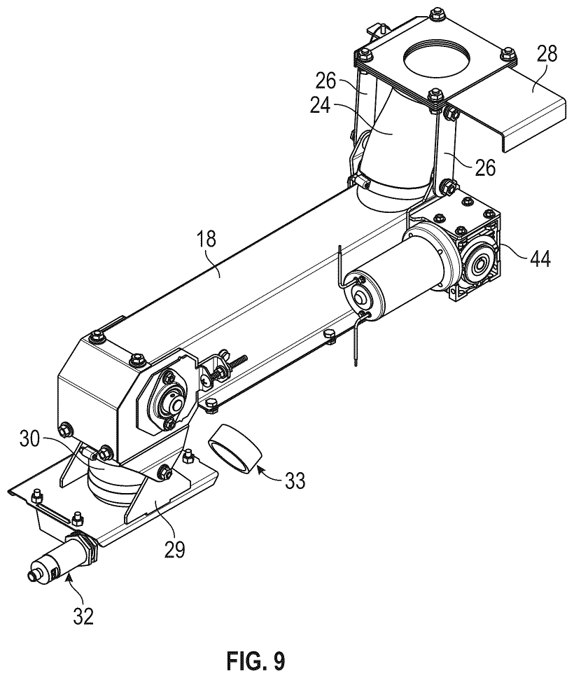

FIG. 10 is a sectional view of the seed conveyor shown in FIG. 9.

### DETAILED DESCRIPTION

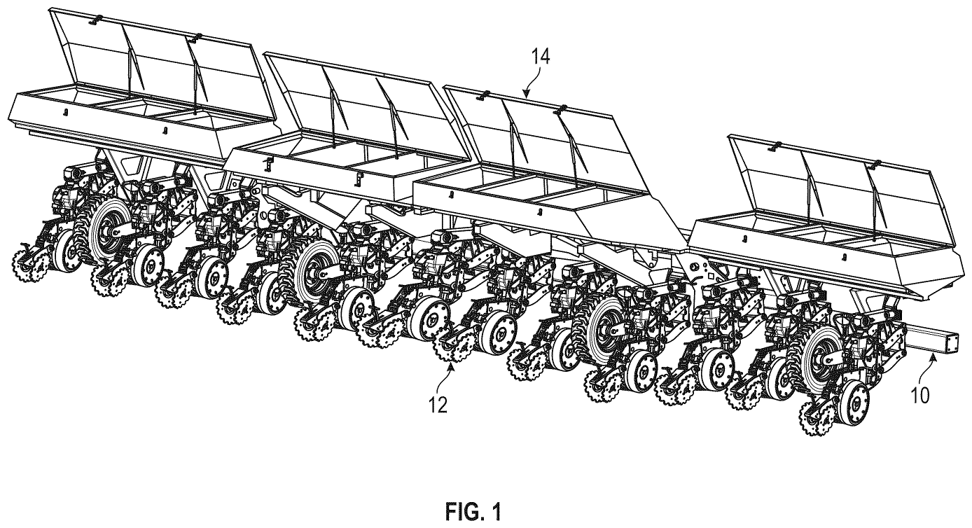

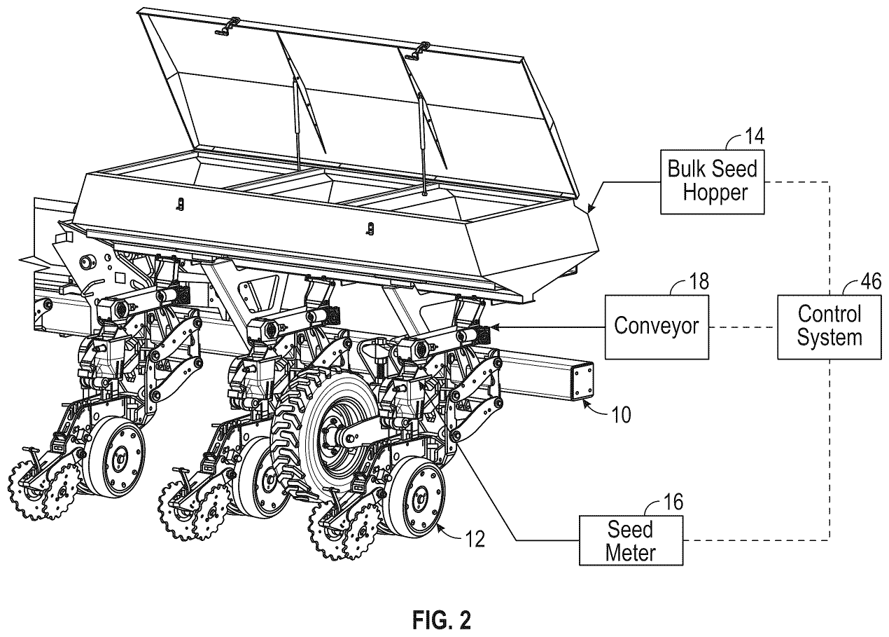

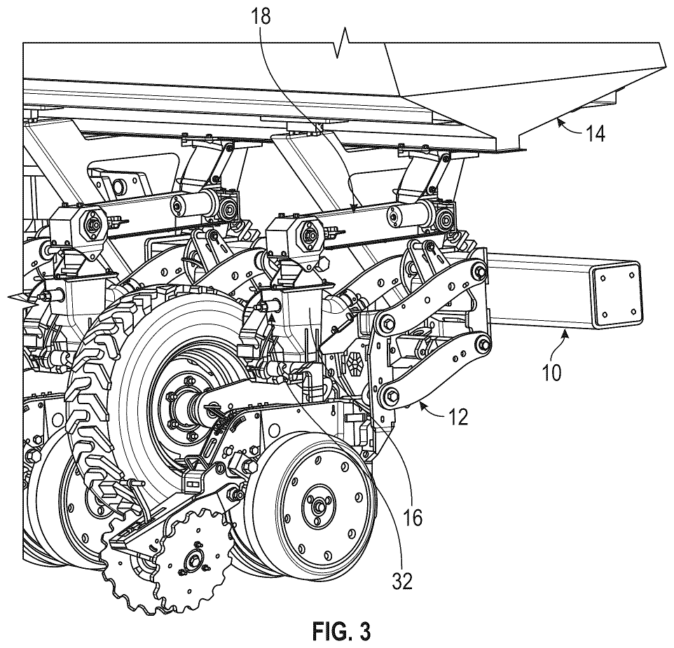

The seed planter assembly of the invention is shown in FIGS. 1-3 and generally includes a toolbar frame 10, a plurality of planter row units 12 pivotally connected to the toolbar frame, bulk seed hoppers 14 fixed on the toolbar frame, a seed meter 16 associated with each planter row unit, and a seed conveyor 18 on each row unit and extending to each seed meter. FIG. 1 shows twelve planter row units 12 mounted on the toolbar frame 10, though the number of row units may vary. Also, FIG. 1 shows four seed hoppers 14 mounted on the toolbar frame, though the number of hoppers may also vary. The seed meter 16 may be any commercially available meter.

The seed conveyor 18 has an inlet 20 and an outlet 22. A smooth, flexible hose or tube connects the seed conveyor inlet 20 to an outlet of the bulk seed hopper 14. The seed conveyor 18 is also coupled to the seed hopper 14 with a pair of link arms 26. The flexible hose 24 and the link arms 26 allow the seed conveyor 18 to float as the row unit 12 moves upwardly and downwardly with the ground terrain during planting operations.

The coupler or connection of the seed conveyor 18 to the bulk seed hopper 14 includes a slide gate 28, which can be opened and closed to control flow of the seed from the hopper 14, through the hose or tube 24, and into the conveyor 18. Preferably, the slide gate 28 is controlled remotely from the cab of the tractor pulling the toolbar frame 10.

The seed conveyor outlet 22 is coupled to the seed meter 16 via a flexible, smooth hose or tube 30. The conveyor outlet hose 30 extends between the conveyor outlet 22 and the seed meter housing 31, which forms a small receptacle or mini-hopper for the seed meter 16.

The seed meter is modified to include a seed sensor 32, which senses the level or volume of seed in the meter, and sends a signal to a control system in the tractor cab so as to automatically adjust the operation of the seed conveyor 18 so as to maintain a proper level of seed in the meter 16. Thus, the seed level/volume sensor 32 assures that a proper volume or amount of seed is supplied to the seed meter 16, and also assures that the seed meter 16 is not over-filled with seed, which can cause damage to the seed. The seed meter 16 is further modified to close the conventional inlet 17 with a cap 33.

The inlet and outlet hose connections 24, 30 keeps field debris out of the conveyor and seed meter.

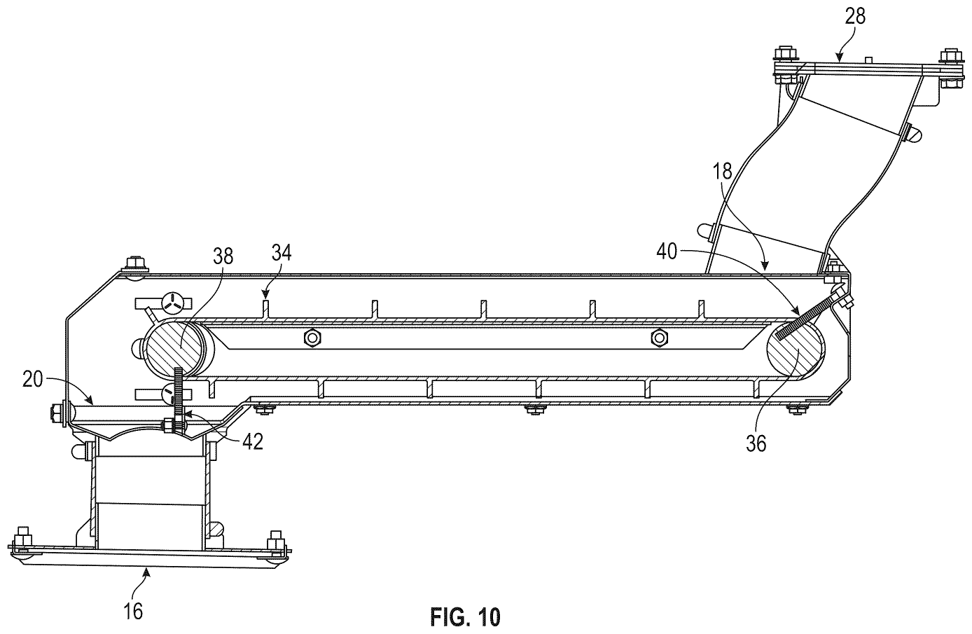

The seed conveyor 18 is a mechanical conveyor which gently transports the seed from the hopper 14 to the seed meter 16, as opposed to a pneumatic conveyor system. The conveyor 18 is oriented substantially horizontally, as shown in the drawings. Preferably, the seed conveyor 18 is a belt conveyor which is more gentle than an auger conveyor. As seen in FIG. 10, in the preferred embodiment, the seed conveyor 18 includes a belt 34 with a drive roller 36 and a tension roller 38. A seed retention brush 40 assures that seed is deposited from the inlet tube 24 onto the belt 34. A seed or belt cleaner brush 42 near the outlet 22 of the conveyor facilitates the discharge of seed into the outlet tube 30 and the seed meter 16. The speed of the conveyor belt 34 is controlled by the operator from the tractor cab via the row unit control system.

The frame-mounted bulk seed hopper 14 and seed conveyor system 18 gently conveys fragile seeds from the hopper 14 to the seed meter 16. The conveyor 18 may utilize an electrical, hydraulic, or mechanical drive system to power the conveyor. The drawings show an electric drive motor 44.

A control system 46 in the tractor cab is operatively connected to each seed meter 16, to the conveyor 18, and to the slide gate 28 to allow for row-by-row control of the amount of seed being delivered from each hopper 14 to each seed meter 16 by each conveyor 18. The farmer in the tractor cab can selectively turn on and off the slide gates, conveyors, and/or seed meters, as desired for various planting conditions or locations. During planting operations, there may be conditions where only a few row units 12 are used for planting seed, such as on the head lands. Such row-by-row control for seed delivery is beneficial to reduce seed waste for areas that do not need planting.

The flexible connection of the conveyor 18 to the hopper 14 via the hose 24 and link arms 26 allow vertical and longitudinal movement of the conveyor inlet 20 during planting operations as the row units 12 move over uneven ground. Thus, the conveyors 18 float with the row units 12.

The smooth flexible inlet hose 24 and outlet hose 30 eliminate or reduce damage to the seeds and seed coatings, as compared to corrugated tubes. Similarly, the gentle seed conveyor 18 minimizes seed and seed coating damage, as compared to pneumatic conveyors. Thus, the planter assembly or system of the present invention improves germination of the seeds, yield from crop harvest, and profitability to the farmer.

Mounting the hoppers 14 on the toolbar frame 10 allows for considerably larger hoppers to be used, for example, up to three times larger than the conventional three bushel peanut seed box planter of the prior art. Thus, plating efficiency is improved due to reduced time for filling the seed hoppers. Also, the mounting configuration of the hoppers 14 on the toolbar frame 10 minimizes overall transport height and keeps the center of mass closer to the planter toolbar frame, which reduces the power needed to raise and lower the row units 12.

The conveyor system of the present invention can be used for various types of delicate seed or seed that is difficult to deliver to the seed meters via conventional seed delivery systems. The improved efficiencies and improved germination of seeds leads to improved profitability for the operator.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A bulk seed planter system, comprising:
a tool bar assembly with a frame;
a bulk seed hopper on the frame and having a seed outlet;
a row planter on the frame and having a seed meter; and
a mechanical conveyor mounted to the frame and having an inlet to receive seed from the bulk seed hopper and an outlet to discharge seed into the seed meter.

2. The bulk seed planter system of claim 1 wherein further comprising a tube extending between the seed outlet and the conveyor inlet.

3. The bulk seed planter system of claim 1 further comprising a tube connecting the conveyor outlet to the seed meter.

4. The bulk seed planter system of claim 1 further comprising a flexible connection between the conveyor and the frame.

5. The bulk seed planter system of claim 1 further comprising a seed level sensor on the seed meter to sense a level of seed within the seed meter.

6. The bulk seed planter system of claim 1 further comprising a slide gate at the inlet of the conveyor and the slide gate being movable between open and closed positions.

7. The bulk seed planter system of claim 1 wherein the conveyor is oriented substantially horizontally.

8. The bulk seed planter system of claim 1 wherein the conveyor includes an endless belt.

9. The bulk seed planter system of claim 1 further comprising seed brushes adjacent the conveyor inlet and outlet.

10. The bulk seed planter system of claim 1 further comprising a remote controller for controlling operation of the conveyor and the seed meter.

11. A method of conveying seed from a bulk seed hopper on a frame of a tool bar to a seed meter on a planter row on the frame, comprising:
dropping seed from an outlet on the bulk seed hopper into a mechanical conveyor mounted on the frame;
transporting the seed on the conveyor; and
dropping seed from an outlet on the conveyor into the seed meter.

12. The method of claim 11 further comprising sensing the level of seed in the seed meter and adjusting operation of the conveyor in response to the seed level.

13. The method of claim 11 wherein the seed is transported substantially horizontally on the conveyor.

14. The method of claim 11 further comprising allowing the conveyor to float with the row planter as the row planter traverses a field.

15. The method of claim 11 further comprising passing the seed through hoses to and from the conveyor.

16. The method of claim 11 further comprising opening and closing a slide gate adjacent an inlet of the conveyor.

17. A mechanical conveyor assembly for transporting seeds from a hopper on an agricultural planter frame to a seed meter on row unit on the frame, the mechanical conveyor assembly comprising:
a conveyor having an inlet and an outlet;
a hose connected the hopper and to the inlet of the conveyor;
a hose to connect the outlet of the conveyor and to the seed meter; and
a belt extending between the inlet and the outlet to carry the seeds from the hopper to the seed meter.

18. The mechanical conveyor assembly of claim 17 further comprising a pair of pivotal link arm connecting the conveyor to the frame whereby the conveyor rises and falls as the planter traverses a field.

19. The mechanical conveyor assembly of claim 17 further comprising seed brushes adjacent the conveyor inlet and outlet.

20. The mechanical conveyor assembly of claim 17 further comprising a remote controller for adjusting speed of the conveyor belt.

21. The mechanical conveyor assembly of claim 17 further comprising a slide gate between the conveyor inlet and the hopper, wherein the slide gate is movable between open and closed positions.

22. The mechanical conveyor assembly of claim 21 further comprising a remote controller to move the slide gate between the open and closed positions.

23. An agricultural seed planter, comprising:
a hopper to hold seed;
a plurality of seed meters to dispense seed; and
a plurality of mechanical conveyors adapted to receive seed from the hopper, and each conveyor being associated with one of the seed meters to direct seed from the hopper to the associated seed meter.

24. The agricultural seed planter of claim 23 further comprising a remote controller wherein operation of each conveyor is controlled individually.

25. The agricultural seed planter of claim 23 further comprising a pivotal linkage on each conveyor to flexibly connect the conveyor to the hopper whereby the conveyors float during seed planting operations.

26. The agricultural seed planter of claim 21 further comprising flexible inlet and outlet hoses connecting the conveyors to the hopper and to the seed meters, respectively.

27. The agricultural seed planter of claim 21 wherein each mechanical conveyor is a belt conveyor.

28. The agricultural seed planter of claim 21 wherein each seed meter has a seed sensor to generate a signal corresponding to a volume of seed in the seed meter, and the agricultural seed planter further comprising a remote controller to receive the signal from the seed sensor and then automatically adjust operation of the associated conveyor to maintain a proper amount of seed in the seed meter.
